(19) United States
(12) Patent Application Publication
(10) Pub. No.: US 2014/0339952 A1
(43) Pub. Date: Nov. 20, 2014

(54) ROTOR STRUCTURE OF DRIVE MOTOR

(71) Applicant: HYUNDAI MOTOR COMPANY, Seoul (KR)

(72) Inventors: Myeong Kyu Jung, Seoul (KR); Young Jin Seo, Gyeonggi-do (KR); Dongyeon Han, Seoul (KR)

(73) Assignee: HYUNDAI MOTOR COMPANY, Seoul (KR)

(21) Appl. No.: 14/097,612

(22) Filed: Dec. 5, 2013

(30) Foreign Application Priority Data
May 20, 2013 (KR) 10-2013-0056681

(51) Int. Cl. H02K 1/28

(52) U.S. Cl. CPC H02K 1/28
USPC 310/216.123; 310/216.001

(57) ABSTRACT

A rotor structure of a drive motor is provided. In the rotor structure of a driving motor, a rotor core is divisionally formed in a plurality of core blocks and the core blocks may be combined around an outer side of a rotary shaft.

### CROSS-REFERENCE TO RELATED APPLICATION

This application claims priority to and the benefit of Korean Patent Application No. 10-2013-0056681 filed in the Korean Intellectual Property Office on May 20, 2013, the entire contents of which are incorporated herein by reference.

### BACKGROUND

(a) Field of the Invention

An exemplary embodiment of the present invention relates to a rotor of a drive motor for environmentally-friendly vehicles. More particularly, the present invention relates to a rotor combination structure of a WRSM (Wound Rotor Synchronous Motor) using a division core type.

(b) Description of the Related Art

In general, hybrid vehicles or electric vehicles, which are usually called environmentally-friendly vehicles, are driven by an electric motor (hereafter, also referred to as a “driving motor”) that acquire torque from electric energy. Hybrid vehicles travel in an EV (electric vehicle) mode, which is an electric vehicle mode that uses only the power from a driving motor, or travel in an HEV (hybrid electric vehicle) mode using torque from both an engine and a driving motor as power. Common electric vehicles travel, using torque from a driving motor as power.

Most of the driving motors used for the environmentally-friendly vehicles are PMSMs (Permanent Magnet Synchronous Motor). The PMSMs require improved performance of the permanent magnet to achieve improved performance under a limited layout condition. Neodymium (Nd) in the permanent magnet improves the intensity of the permanent magnet and the dysprosium (Dy) improves demagnetization. However, rare earth metal elements (e.g., Nd and Dy) in the permanent magnet locally lie under the ground in some countries such as China, and the price is very high and frequently fluctuated. Therefore, an induction motor has been recently developed, limitations of an increase in volume, weight, and size has been observed to achieve similar motor performance.

On the other hand, the WRSM that may replace the PMSM has been further developed, as a driving motor that is used as a power source for environmentally-friendly vehicles. The WRSM can achieve the performance by optimal increase of about 10% to the PMSM and the permanent magnet of the PMSM is replaced by electromagnetizing the rotor when applying current by winding a coil around the rotor. The WRSM has a structure in which a coil is wound around the stator and but the rotor. The WRSM requires an increase of the wire space factor to reduce loss and increase efficiency, and to increase the wire space factor, a division core type of forming a stator and a rotor into divisional core blocks and by inserting a bobbin in the core blocks is used.

In the division core type of WRSM, the rotor is disposed within a stator with a predetermined gap, a magnetic field is generated, when power is applied to the coils of the stator and the rotor, and the rotator is rotated by a magnetic action generated between the stator and the rotor. Accordingly, the division core type of WRSM can be easily manufactured due to being able to wind the coil around the core blocks, and since the wire space factor increases, copper loss (loss) may be reduced and the efficiency may increase.

Accordingly, as an example of the related art, in a division core type of WRSM, as shown in FIG. 1, a rotor 2 is placed inside a stator 1 with a predetermined spacing. Such a rotor 2 includes a rotor body 3 fitted on a shaft 9 and a plurality of core blocks 5 fitted on the rotor body 3. A protrusion 8 is formed at the lower end of the core blocks 5, where a coil 4 is wound, and a protrusion groove 6 is formed on the outer side of the rotor body 3. Accordingly, the rotor 2 can be formed by fitting the protrusions 8 on the core blocks 5 into the protrusion grooves 6.

However, in the rotor 2 of the division core type of WRSM, a plurality of core blocks 5 are fitted into the rotor body 3, and thus the connection portions (e.g., division core joints) of the rotor body 3 and the core blocks 5 are positioned on a magnetic flux path A1, to influence the flow of the magnetic flux and may reduce the output and efficiency of the synchronous motor.

That is, according to the conventional scheme, division core joints corresponds to the magnetic flux path A1 so as to act as a resistance blocking flux, and thus the characteristic of a motor may be deteriorated.

Furthermore, stress occurs at an assembly surface of the rotor body 3 and the core blocks 5 and characteristic of material may be changed at the portion suffering from the stress, which consequently increase magnetic resistivity may be increased to deteriorate output and efficiency of a motor.

The above information disclosed in this section is only for enhancement of understanding of the background of the invention and therefore it may contain information that does not form the prior art that is already known in this country to a person of ordinary skill in the art.

### SUMMARY

The present invention provides a rotor structure of a driving motor that may increase wire space factor of a coil without influencing the flow of main magnetic flux of a rotor, and may improve the output and efficiency of a motor. An exemplary embodiment of the present invention provides a rotor structure of a driving motor, in which a rotor core may be divisionally formed in a plurality of core blocks and the core blocks may be combined around the outer side of a rotary shaft.

In the rotor structure of a driving motor according to an exemplary embodiment of the present invention, the joints between the core blocks and the rotor shaft may be positioned out of a main magnetic field path of the rotor core. The core block may have a body on which a coil may be substantially wound, and a fitting portion integrally connected to the body and forcibly fitted in the outer side of the rotary shaft. A bobbin may be inserted in the bodies of the core blocks and a plurality of protrusion grooves may be formed axially around the outer side of the rotary shaft. Further, fitting protrusions fitted within the protrusion grooves may protrude from the fitting portions.

Another exemplary embodiment of the present invention provides a rotor structure of a driving motor that may includes a rotor core divisionally formed in a plurality of core blocks, in which the core blocks may be directly fixed around the outer side of the rotary shaft, fixing protrusions fitted in the outer side of the rotary shaft may be formed at the core blocks, and a plurality of protrusion grooves where the fitting protrusions are forcibly and axially fitted may be formed around the outer side of the rotary shaft. In addition, a stress occurring portion between the core blocks and the rotary shaft is apart from a main magnetic flux path. In addition, the core blocks may form contact surfaces that are adjacent and contact sides, and a main magnetic field path may be formed by the contact surfaces.

According to exemplary embodiments of the present invention, since the rotor core may be divisionally formed in a plurality of core blocks and the core blocks may be directly and axially fixed around the outer side of a rotary shaft, the entire rotor may be manufactured and assembled more easily.

Further, according to an exemplary embodiment of the present invention, since a wire may be wound around the core blocks and then assembled, it may be possible to reduce the defective proportion of winding, to improve no-load counter electromotive voltage by positioning the assembled sides of the core blocks out of the main magnetic flux path, to minimize the distance between adjacent coils, to improve the efficiency of a motor by avoiding resistance against the flow of the magnetic flux in the rotor, and to improve the wire space factor of a coil. In addition, since the joints between the core blocks and the rotary shaft may be positioned out of the main magnetic flux path of the rotor core in an exemplary embodiment of the present invention, the joints may not influence the flow of the main magnetic flux of the rotor core, such that the efficiency of a motor may be further improved.

### BRIEF DESCRIPTION OF THE DRAWINGS

The drawings are provided for reference in describing exemplary embodiments of the present invention and the spirit of the present invention should not be construed only by the accompanying drawings.

FIG. 1 is an exemplary view showing a rotor of a WRSM (Wound Rotor Synchronous Motor) according to the related art;

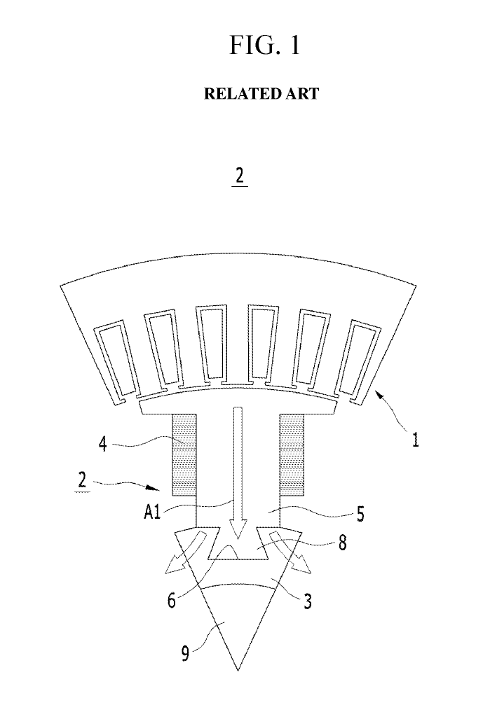

FIG. 2 is an exemplary front view of a rotor of a driving motor according to an exemplary embodiment of the present invention;

FIG. 3 is an exemplary detailed view showing the combination structure of a rotor core and a rotor shaft used for the rotor of the driving motor according to an exemplary embodiment of the present invention; and

FIG. 4 is an exemplary assembly front view showing the combination structure of the rotor core and the rotor shaft used for the rotor of the driving motor according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, fuel cell vehicles, and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The unrelated parts to the description of the exemplary embodiments are not shown to make the description clear and like reference numerals designate like element throughout the specification.

Further, the sizes and thicknesses of the configurations shown in the drawings are provided selectively for the convenience of description, so that the present invention is not limited to those shown in the drawings and the thicknesses are exaggerated to make some parts and regions clear. Discriminating the names of components with the first, the second, etc. in the following description is for discriminating them for the same relationship of the components and the components are not limited to the order in the following description.

Further, the terms, “ . . . unit”, “ . . . mechanism”, “ . . . portion”, “ . . . member” etc. used herein mean the unit of inclusive components performing at least one or more functions or operations. Although exemplary embodiment is described as using a plurality of units to perform the exemplary process, it is understood that the exemplary processes may also be performed by one or plurality of modules.

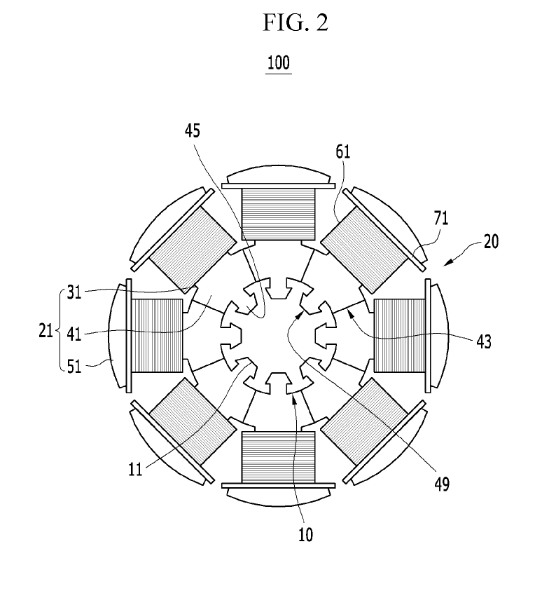

FIG. 2 is an exemplary front view of a rotor of a driving motor according to an exemplary embodiment of the present invention. Referring to FIG. 2, a rotor 100 of a driving motor according to an exemplary embodiment of the present invention may be available for a WRSM (Wound Rotor Synchronous Motor) as a driving motor to acquire a driving force from electric energy in environmentally-friendly vehicles. For example, the WRSM, in which the rotor may be electromagnetized when current is applied, by winding coil around the stator and the rotor, may generate driving torque from the electromagnetic attractive force and repulsive force between the electromagnet of the rotor and the electromagnet of the stator.

The rotor 100 of a driving motor which is used for the WRSM described above may use a division core type which may be manufactured and assembled more easily, minimizing the space between the division cores and improving the output and efficiency of the motor since there may be minimal influence the path of main magnetic flux. In other words, in the exemplary embodiment of the present invention, stress may be generated at the joint (e.g., bonded surface) of the division cores and the rotor 100 of a driving motor with the joint of the division cores not influencing the main magnetic flux path may be provided.

Further, the rotor 100 of a driving motor according to an exemplary embodiment of the present invention may include a rotary shaft 10 and a rotor core 20 combined with the rotor shaft 10. The rotor shaft 10 is a rotary shaft that may be combined with the rotor core 20, as a rotational center of the rotor core 20 disposed with a predetermined space within the stator (not shown in the figure). In other words, the rotor core 20 may be disposed with a predetermined gap inside the stator (not shown in the figure), a magnetic field may be generated when power is applied to the coil of the stator and the rotor core 20, and the rotor core may rotate with the rotary shaft 10 by the magnetic action therebetween.

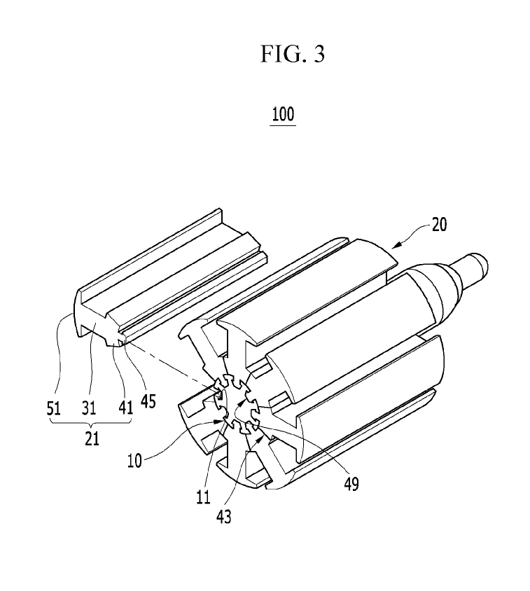

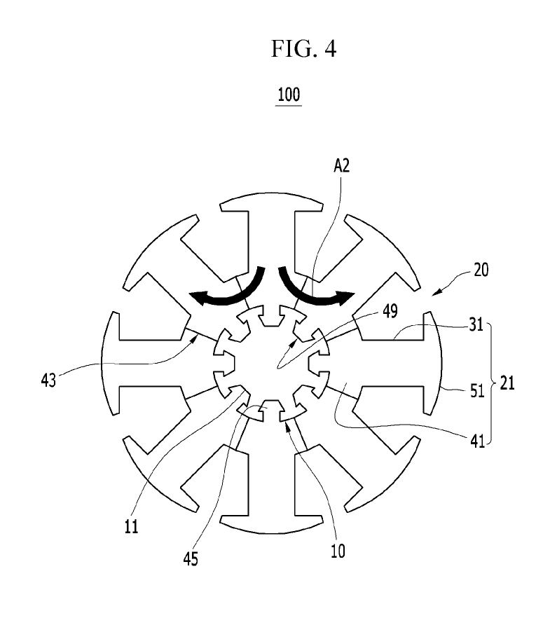

FIG. 3 is an exemplary detailed view showing the combination structure of a rotor core and a rotor shaft used for the rotor of the driving motor according to an exemplary embodiment of the present invention and FIG. 4 is an exemplary assembly front view showing the combination structure of the rotor core and the rotor shaft used for the rotor of the driving motor according to an exemplary embodiment of the present invention. Referring to FIGS. 2 to 4, the rotor core 20 may be divisionally formed in a plurality of core blocks 21. The core blocks 21 may be combined with each other around the outer side of the rotary shaft 10.

Furthermore, at the joint 49 of the core block 21 and the rotary shaft 10, assembly stress of the core block 21 and the rotary shaft 10 may be generated and the joint 49 may be formed out of the main flux path A2 of the rotary core 20. In particular, in an exemplary embodiment of the present invention, the core blocks 21 may have a body 31 on which a coil 61 (e.g., a “rotary coil” in the art) may be wound, a fitting portion 41 integrally connected to the body 31 and forcibly and axially fitting in the outer side of the rotary shaft 10, and a loop portion 51 formed at the upper portion of the body 31 in the figures.

The body 31 may be disposed between the fitting portion 41 and the loop portion 51 and a bobbin 71 may be inserted in the body 31. The bobbin 71 may be a bobbin unit known in the art, thus a detailed description thereof is omitted. The fitting portions, which may be the lower portion of the core blocks 21 in the figures, may be circumferentially in contact with each other and may be forcibly and axially fitted in the outer side of the rotary shaft 10. Contact surfaces 43 that are sides in contact with each other for adjacent core blocks 21 may be formed at the fitting portions 41 and may be formed as the main magnetic flux path A2 of the rotor core 20 stated above.

Additionally, a fitting protrusion 45 that may be forcibly and axially fitted in the outer side of the rotary shaft 10 may be formed at the lower end of the fitting portion 41. The fitting protrusion 45 may be axially slid into the rotary shaft 10 and hook protrusions that are not separated may be disposed around the outer side of the rotary shaft 10. The loop portion 51 may be formed at the upper end of the body 31 and may form a loop surface curved in a circular shape. In other words, the whole loop surfaces of the core blocks 21 assembled with the rotary shaft 10 may be formed in a substantially circular shape by the loop portions 51.

A plurality of protrusion grooves 11 may be formed axially around the outer side of the rotary shaft 10. The fitting protrusions 45 of the core blocks 12 may be forcibly fitted in to the protrusion grooves 11. In the combination structure of the core blocks 21 and the rotary shaft 10, assembly stress of the core blocks 21 and the rotary shaft 10 may be generated at the joints 49 of the fitting protrusions 45 and the protrusion grooves 11. In particular, the joints 49 of the core blocks 21 and the rotary shaft 10 may be positioned out of the main magnetic flux path A2 of the rotary core 20 stated above. That is, the stress occurring portion between the core blocks 21 and the rotary shaft 10 may be positioned out of the main magnetic flux path A2 of the rotary core 20.

Therefore, according to the rotor of a driving motor of an exemplary embodiment of the present invention, since the rotor core 20 may be divisionally formed in a plurality of core blocks 21 and the core blocks 21 may be directly and axially fixed around the outer side of the rotary shaft 10, the entire rotor 100 may be manufactured and assembled more easily. Further, in an exemplary embodiment of the present invention, since a coil may be wound around the core blocks 21 and then assembled, the winding volume of the coil 61 may be reduced, the distance between adjacent coils may be minimized, the efficiency of a motor may be improved by avoiding resistance against the flow of magnetic flux in the rotor, and the wire space factor of the coil 61 may be improved.

In addition, assembly stress of the core blocks 21 and the rotary shaft 10 may be generated at the joint of the fitting protrusion 51 and the protrusion groove 11 and the portion where the stress is exerted may be positioned out of the main magnetic flux path of the rotor, to improve no-load counter electromotive voltage. Improvement of the no-load counter electromotive voltage may increase the torque and the output of a motor when the same current is applied and increase the reduction efficiency of copper loss (loss) of a rotor due to reduction of current applied to the rotor. Further, since the joints 49 between the core blocks 21 and the rotary shaft 10 may be positioned out of the main magnetic flux path A2 of the rotor core 20, the joints 49 may not influence the flow of the main magnetic flux of the rotor core 20, further improving the efficiency of a motor.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

Description of symbols

| | | | |
|---|---|---|---|
| 10 | rotary shaft | 11 | protrusion groove |
| 20 | rotor core | 21 | core block |
| 31 | body | 41 | fitting portion |
| 43 | contact surface | 45 | fitting protrusion |
| 49 | joint | 51 | loop portion |
| 61 | coil | 71 | bobbin |
| A2 | main magnetic field path | | |

What is claimed is:

1. A rotor structure of a driving motor, comprising:
a rotor core divisionally formed in a plurality of core blocks, wherein the plurality of core blocks are combined around an outer side of a rotary shaft.

2. The rotor structure of claim 1, wherein the joints between the core blocks and the rotor shaft are positioned out of a main magnetic field path of the rotor core.

3. The rotor structure of claim 1, wherein the core block includes:
a body in which a coil is substantially wound; and
a fitting portion integrally connected to the body and forcibly fitted in the outer side of the rotary shaft.

4. The rotor structure of claim 3, further comprising:
a bobbin inserted in the body of each of the plurality of core blocks.

5. The rotor of claim 3, further comprising:
a plurality of protrusion grooves formed axially around the outer side of the rotary shaft; and
a plurality of fitting protrusions fitted in the protrusion grooves and protrude from the fitting portions.

6. A rotor structure of a driving motor comprising:
a rotor core divisionally formed in a plurality of core blocks, wherein the core blocks are directly fixed around an outer side of the rotary shaft;
a plurality of fixing protrusions fitted in the outer side of the rotary shaft are formed at the core blocks; and
a plurality of protrusion grooves where the fitting protrusions are forcibly and axially fitted are formed around the outer side of the rotary shaft.

7. The rotor structure of claim 6, wherein a stress occurring portion between the core blocks and the rotary shaft is apart from a main magnetic flux path.

8. The rotor structure of claim 6, wherein the core blocks form contact surfaces that are adjacent and contact sides, and a main magnetic field path is formed by the contact surfaces.
